(19) United States
(12) Patent Application Publication
(10) Pub. No.: US 2025/0083239 A1
(43) Pub. Date: Mar. 13, 2025

(54) BAND SAW

(71) Applicant: MILWAUKEE ELECTRIC TOOL CORPORATION, Brookfield, WI (US)

(72) Inventors: Wesley S. Bassindale, Wauwatosa, WI (US); Terry L. Timmons, Oconomowoc, WI (US); Carmen J. Castanos, Shorewood, WI (US)

(21) Appl. No.: 18/808,428

(22) Filed: Aug. 19, 2024

Related U.S. Application Data
(60) Provisional application No. 63/582,047, filed on Sep. 12, 2023.

(51) Int. Cl. B23D 53/12; B23D 55/06

(52) U.S. Cl. CPC B23D 53/12; B23D 55/065

(57) ABSTRACT

A handheld band saw includes a saw blade, a housing having a deck surrounding the saw blade, and a handle coupled to the housing and configured to be grasped by a user during a cutting operation. The deck includes a mounting hub extending from the deck. A motor is supported by the housing for driving a drive wheel spindle. The handheld band saw further includes a drive wheel assembly including a drive wheel driven by the drive wheel spindle and a driven wheel driven by the drive wheel via the saw blade. A bearing supports the drive wheel for rotation on the mounting hub. The mounting hub includes an aperture through which the drive wheel spindle extends.

### CROSS-REFERENCE TO RELATED APPLICATIONS

This application claims priority to U.S. Provisional Patent Application No. 63/582,047, filed on Sep. 12, 2023, the entire content of which is incorporated herein by reference.

### FIELD OF THE DISCLOSURE

The present invention relates to power tools, and more specifically to band saws.

### BACKGROUND OF THE DISCLOSURE

The present invention relates to a handheld saw, and, more particularly, to a portable, handheld band saw. Handheld band saws are used to cut a variety of workpieces, such as pipes, rods, studs, and blocks. A cordless, compact band saw allows for cutting operations in tight spaces or awkward angles for plumbing, electrical, remodeling, and HVAC applications.

### SUMMARY OF THE DISCLOSURE

The present disclosure provides, in one aspect, a handheld band saw including a saw blade and a housing including a deck surrounding the saw blade. The deck has a mounting hub extending from the deck. The band saw further includes a handle coupled to the housing and configured to be grasped by a user during a cutting operation, a motor supported by the housing for driving a drive wheel spindle, and a drive wheel assembly. The drive wheel assembly includes a drive wheel driven by the drive wheel spindle and a driven wheel driven by the drive wheel via the saw blade. The band saw further includes a bearing that supports the drive wheel for rotation on the mounting hub, wherein the mounting hub includes an aperture through which the drive wheel spindle extends.

The present disclosure provides, in another aspect, a handheld band saw including a saw blade and a housing. The housing has a deck surrounding the saw blade, a handle configured to be grasped by a user during a cutting operation, and a battery receptacle for receiving a battery. The handheld band saw further includes a motor supported by the housing for driving a drive wheel spindle, a drive wheel driven by the drive wheel spindle and a driven wheel driven by the drive wheel via the saw blade, a mounting hub extending from the deck and surrounded radially by the drive wheel; and a bearing that supports the drive wheel for rotation on the mounting hub. The bearing is disposed on an outer periphery of the mounting hub between the mounting hub and the drive wheel.

Other features and aspects of the invention will become apparent by consideration of the following detailed description and accompanying drawings.

### BRIEF DESCRIPTION OF THE DRAWINGS

FIG. 1 is a side view of a handheld band saw.

FIG. 2 is an opposite side view of the handheld band saw of FIG. 1.

FIG. 3 is a cross-sectional view of a drive mechanism taken along line 3-3 of FIG. 1, illustrating a motor, a transmission, and a drive wheel assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

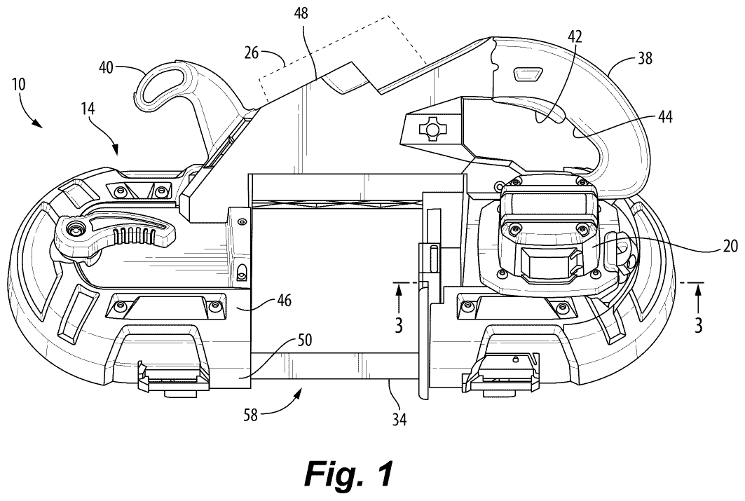

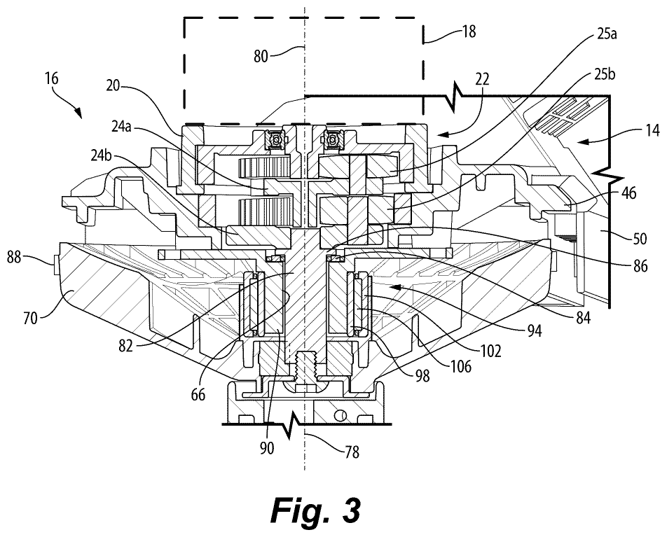

FIG. 1 illustrates a handheld band saw 10 including a frame or housing 14 supporting a drive mechanism 16. The drive mechanism 16 includes a motor 18 disposed within a motor housing 20 and a transmission 22 (FIG. 3) driven by the motor 18. In some embodiments, at least a portion of the transmission 22 is also disposed within the motor housing 20. In the illustrated construction of the band saw 10, the motor 18 is configured as a DC brushless motor, and the band saw 10 includes a removable, rechargeable battery 26 for supplying power to the motor 18. The drive mechanism 16 further includes a drive wheel assembly 30, which is driven by the motor 18 via the transmission 22. The motor 18, the transmission 22, and the drive wheel assembly 30 are supported by the housing 14. The motor housing 20 is also coupled to and supported by the housing 14. As shown in FIG. 3, the transmission 22 is a multi-stage planetary transmission 22, with each stage including a carrier 24a, 24b and a plurality of planet gears 25a, 25b rotatably supported upon the respective carriers 24a, 24b. The transmission 22 may include different gear train arrangements configured to provide a low-speed, high-torque output from the high-speed, low-torque input of the motor 18. The drive mechanism 16 is operable to drive a continuous band saw blade 34 to cut a workpiece (FIG. 1).

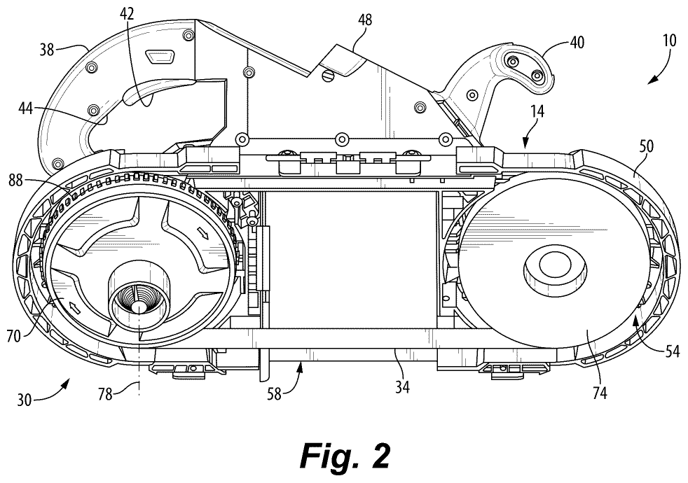

With continued reference to FIG. 1, the housing 14 includes a main or first handle 38 and an auxiliary or second handle 40. The first handle 38 is provided with a trigger 42 to selectively supply power to the band saw 10. The trigger 42 is disposed adjacent a gripping portion 44 of the handle 38 where a user grasps the band saw 10. In the illustrated construction of the band saw 10, the battery 26 is within a battery receptacle 48 of the housing 14 between the first handle 38 and the second handle 40. The battery 26 is an 18-volt battery. The trigger 42 is operable to control operation of the motor 18. Specifically, the battery 26 selectively supplies power to the motor 18 when the trigger 42 is actuated. The housing 14 of the band saw 10 also includes a deck 46 and a guard 50 coupled to the deck 46. In some embodiments, the battery 26 may be supported by the deck 46. The deck 46 and the guard 50 form a cavity 54 (FIG. 2) in which the drive wheel assembly 30 and the band saw blade 34 are at least partially positioned. The deck 46 defines an opening or cut zone 58. The deck 46 and the guard 50 substantially cover the band saw blade 34 when the blade 34 is in a shielded position (i.e., when the blade 34 is not within the cut zone 58; FIG. 1). However, the deck 46 and the guard 50 do not cover the band saw blade 34 when the blade 34 is in an exposed position (i.e., when the blade 34 passes through the cut zone 58). In the exposed position, the blade 34 is fully exposed and unobstructed by the guard 50, allowing workpieces to be cut when entering the cut zone 58.

With reference to FIGS. 2 and 3, the drive wheel assembly 30 includes a drive wheel 70 that is driven by the motor 18 and a driven wheel 74 that is driven by the drive wheel 70 via the saw blade 34. Portions of the drive wheel 70 and the driven wheel 74 are covered by the deck 46 and the guard 50. The drive wheel 70 rotates about a drive wheel axis 78 defined by a drive wheel spindle 82 (FIG. 3). At one end, the drive wheel spindle 82 is coupled to and driven by the second stage carrier 24b of the planetary transmission 22. At the other end, the drive wheel spindle 82 is keyed to the drive wheel 70, such that the drive wheel spindle 82 and the drive wheel 70 co-rotate. The drive wheel spindle 82 also extends from the transmission 22 through an aperture 66 in the deck 46 of the housing 14. The aperture 66 is diametrically larger than the drive wheel spindle 82, such that the aperture 66 does not engage or support the drive wheel spindle 82. The drive wheel spindle 82 is axially supported by a thrust bearing 84 adjacent the carrier 24b. Specifically, the thrust bearing 84 engages and axially supports a flange 86 of the drive wheel spindle 82 that extends radially outward from the drive wheel spindle 82. The thrust bearing 84 is supported by a surface of the deck 46 that is generally perpendicular to the drive wheel axis 78, such that the thrust bearing 84 rotates (i.e., rolls) between the flange 86 and the deck 46, and transfers an axial thrust load on the drive wheel spindle 82 to the deck 46. The flange 86 is upstream (from the perspective of transfer of rotation) the thrust bearing 84, such that the flange 86 is disposed between the carrier 24b and the thrust bearing 84. The drive wheel 70 is drivingly connected to the motor 18 via the transmission 22 and the drive wheel spindle 82, thereby receiving torque from the motor 18 via the transmission 22 and the drive wheel spindle 82. In the illustrated construction of the band saw 10, a rotational axis 80 of the motor 18 is coaxially aligned with the drive wheel axis 78. In other embodiments, the rotational axis 80 and the drive wheel axis 78 may be parallel or at some other oblique angle relative to each other. A tire 88 is coupled to the outer peripheral surface of each of the wheels 70, 74 (although only one of which is shown). Each tire 88 grips the saw blade 34 to drive motion thereof.

With reference to FIG. 3, the band saw 10 further includes a mounting hub 90 extending downward along the drive wheel axis 78 from the deck 46. The mounting hub 90 is surrounded radially by the drive wheel 70. The thrust bearing 84 is disposed between the mounting hub 90 and the flange 86. The mounting hub 90 includes the aperture 66, such that the aperture 66 extends through the mounting hub 90. The drive wheel spindle 82, therefore, also extends through the mounting hub 90, but does not contact or engage the mounting hub 90. A needle bearing 94 is coupled to an outer periphery of the mounting hub 90. Specifically, the needle bearing 94 is coupled between the mounting hub 90 and the drive wheel 70. As such, the drive wheel 70 (and therefore the drive wheel spindle 82) is supported for rotation about the drive wheel axis 78 on the mounting hub 90 via the needle bearing 94. The needle bearing 94 includes an inner race 98 engaged with the outer periphery of the mounting hub 90, an outer race 102 engaged with an inner periphery of the drive wheel 70, and a plurality of rollers 106 disposed between the inner race 98 and the outer race 102. The rollers 106 enable the outer race 102 to rotate relative to the inner race 98 since the inner race 98 is engaged with the non-rotatable (i.e., stationary) mounting hub 90. In other embodiments, the needle bearing 94 may alternatively be a ball bearing, a bushing, or some other similar mechanism that supports the drive wheel 70 for rotation.

Although only a single mounting hub 90 (i.e., drive wheel mounting hub) is shown and described as supporting the drive wheel 70, the band saw 10 includes another mounting hub (i.e., a driven wheel mounting hub) for the driven wheel 74 that is similar to the drive wheel mounting hub. That is, another needle bearing is also supported on the driven wheel mounting hub, where it supports the driven wheel for rotation about the driven wheel mounting hub.

Various features of the invention are set forth in the following claims.

What is claimed is:

1. A handheld band saw comprising:
a saw blade;
a housing including a deck surrounding the saw blade, the deck having a mounting hub extending from the deck;
a handle coupled to the housing and configured to be grasped by a user during a cutting operation;
a motor supported by the housing for driving a drive wheel spindle;
a drive wheel assembly including a drive wheel driven by the drive wheel spindle and a driven wheel driven by the drive wheel via the saw blade; and
a bearing that supports the drive wheel for rotation on the mounting hub, wherein the mounting hub includes an aperture through which the drive wheel spindle extends.

2. The handheld band saw of claim 1, wherein the bearing is a needle bearing including an inner race engaged with the mounting hub, an outer race engaged with the drive wheel, and a plurality of rollers disposed between the inner race and the outer race, allowing relative rotation between the inner race and the outer race.

3. The handheld band saw of claim 1, wherein the drive wheel spindle is driven about a drive wheel axis, wherein the drive wheel spindle transfers torque from the motor to the drive wheel.

4. The handheld band saw of claim 3, wherein the mounting hub extends along the drive wheel axis.

5. The handheld band saw of claim 1, wherein the housing further includes a guard coupled to the deck, wherein the deck and the guard cooperatively surround the saw blade in a shielded position, and wherein the deck and the guard define a cut zone through which the saw blade passes in an exposed position to engage a workpiece.

6. The handheld band saw of claim 1, wherein the aperture is diametrically larger than the drive wheel spindle, such that the drive wheel spindle is not supported by the aperture of the mounting hub.

7. The handheld band saw of claim 1, further comprising a transmission positioned between the motor and the drive wheel spindle, wherein the drive wheel spindle is coupled to and driven by a carrier of the transmission.

8. The handheld band saw of claim 7, wherein the drive wheel spindle includes a radially outward-extending flange adjacent the carrier, and wherein the band saw further comprises a thrust bearing adjacent an opposite side of the flange as the carrier.

9. The handheld band saw of claim 8, wherein the thrust bearing is disposed between the flange and the mounting hub.

10. The handheld band saw of claim 1, wherein the handle is a first handle and the band saw further includes a second handle spaced away from the first handle and a battery removably coupled to the housing adjacent at least the first handle, wherein the battery, when coupled to the housing, is configured to provide power to the motor.

11. The handheld band saw of claim 10, further comprising a trigger disposed adjacent a gripping portion of the first handle, wherein power from the battery is supplied to the motor when the trigger is actuated.

12. A handheld band saw comprising:
a saw blade;
a housing including:
a deck surrounding the saw blade,
a handle configured to be grasped by a user during a cutting operation, and
a battery receptacle for receiving a battery;
a motor supported by the housing for driving a drive wheel spindle;
a drive wheel driven by the drive wheel spindle and a driven wheel driven by the drive wheel via the saw blade;
a mounting hub extending from the deck and surrounded radially by the drive wheel; and
a bearing that supports the drive wheel for rotation on the mounting hub, wherein the bearing is disposed on an outer periphery of the mounting hub between the mounting hub and the drive wheel.

13. The handheld band saw of claim 12, wherein the handle is a first handle and the band saw further includes a second handle spaced away from the first handle, wherein the battery receptacle is disposed adjacent at least the first handle, and wherein the battery, when coupled to the battery receptacle, is configured to provide power to the motor.

14. The handheld band saw of claim 13, further comprising a trigger disposed adjacent a gripping portion of the first handle, wherein power from the battery is supplied to the motor when the trigger is actuated.

15. The handheld band saw of claim 12, further comprising a planetary transmission between the motor and the drive wheel spindle, wherein the planetary transmission includes a carrier coupled for co-rotation with the drive wheel spindle.

16. The handheld band saw of claim 12, wherein the bearing is a needle bearing including an inner race engaged with the mounting hub, an outer race engaged with the drive wheel, and a plurality of rollers disposed between the inner race and the outer race, allowing the outer race to co-rotate with the drive wheel relative to the inner race.

17. The handheld band saw of claim 12, wherein the drive wheel spindle is driven about a drive wheel axis, and wherein the drive wheel spindle transfers torque from the motor to the drive wheel.

18. The handheld band saw of claim 17, wherein the mounting hub extends along the drive wheel axis, and wherein the motor defines a rotational axis that is coaxial with the drive wheel axis.

19. The handheld band saw of claim 12, wherein the mounting hub includes an aperture that is diametrically larger than the drive wheel spindle, such that the drive wheel spindle is not supported by the aperture of the mounting hub.

20. The handheld band saw of claim 12, further comprising a thrust bearing positioned between a radially outward extending flange on the drive wheel spindle and the mounting hub, wherein the thrust bearing is configured to absorb a thrust load applied to the drive wheel spindle.
